(19) United States
(12) Patent Application Publication
(10) Pub. No.: US 2026/0351805 A1
(43) Pub. Date: Nov. 5, 2026

(54) CURRENT-CARRYING COMPONENT MANUFACTURING METHOD AND CURRENT-CARRYING COMPONENT

(71) Applicant: NACHI-FUJIKOSHI CORP., Tokyo (JP)

(72) Inventors: Nobuyuki FUNAHIRA, Toyama (JP); Maki Satake, Toyama (JP); Shingo Kusano, Toyama (JP); Takuma Noguchi, Toyama (JP)

(21) Appl. No.: 19/637,299

(22) Filed: Apr. 2, 2026

(30) Foreign Application Priority Data
Apr. 4, 2025 (JP) 2025-062715

(51) Int. Cl. H01M 50/516; H01M 50/503; H01M 50/522

(52) U.S. Cl. CPC H01M 50/516; H01M 50/503; H01M 50/522

(57) ABSTRACT

A current-carrying component manufacturing method according to the present invention includes a first step of abutting an end surface of a plate-shaped metal foil material in which a plurality of metal foils are laminated and an end surface of a metal plate material having a thickness substantially same as the metal foil material in a laminating direction of the plurality of metal foils, and a second step of performing friction stir spot welding between the metal foil material and the metal plate material by rotating and inserting a friction stir welding tool into the metal foil material and the metal plate material at a position including a part of a boundary between the end surface of the metal foil material and the end surface of the metal plate material butted together.

### TECHNICAL FIELD

The present invention relates to a current-carrying component manufacturing method and a current-carrying component.

### BACKGROUND ART

Conventionally, friction stir spot welding is well known as a spot welding method using a friction stir phenomenon. Patent Literature 1 discloses a technique in which an end of a metal foil material and an end of a metal plate material are overlapped with each other in a thickness direction to perform friction stir spot welding.

### CITATION LIST

### Patent Literature

Patent Literature 1: JP 2015-123488

### DISCLOSURE OF INVENTION

### Problem to be Solved by the Invention

Here, in a current-carrying component such as a bus bar that electrically connects a plurality of battery cases mounted on an electric vehicle, a method of overlapping an end of a metal foil material and an end of a metal plate material and performing friction stir spot welding is considered. In this case, a joint thickness becomes thicker than the thickness of the metal foil material or the thickness of the metal plate material. For example, when the joint thickness is thicker than the thickness of the metal foil material or the thickness of the metal plate material, a deformable region of the metal foil material is limited, and the flexibility of the bus bar is reduced. Therefore, there is a possibility that the bus bar cannot be attached to at least one of two battery cases when heights of the two battery cases electrically connected by the bus bar are greatly different.

The present invention has been made in view of the above problem, and an object of the present invention is to provide a current-carrying component manufacturing method and a current-carrying component that are capable of suppressing a thickness of a joint when the joint is formed between a metal foil material and a metal plate material by friction stir spot welding.

### Means for Solving Problem

In order to solve the above-described problem and achieve the object,
[1] a current-carrying component manufacturing method according to the present invention includes: a first step of abutting an end surface of a plate-shaped metal foil material in which a plurality of metal foils are laminated and an end surface of a metal plate material having a thickness substantially same as the metal foil material in a laminating direction of the plurality of metal foils; and a second step of performing friction stir spot welding between the metal foil material and the metal plate material by rotating and inserting a friction stir welding tool into the metal foil material and the metal plate material at a position including a part of a boundary between the end surface of the metal foil material and the end surface of the metal plate material butted together.
[2] In the current-carrying component manufacturing method according to the present invention, in the invention of the above-described [1], the end surface of the metal plate material and the end surface of the metal foil material butted together are planes substantially parallel to the laminating direction.
[3] In the current-carrying component manufacturing method according to the present invention, in the invention of the above-described [1], each of the end surface of the metal plate material and the end surface of the metal foil material butted together is an inclined surface that is inclined with respect to the laminating direction.
[4] In the current-carrying component manufacturing method according to the present invention, in the invention of the above-described [2], the friction stir welding tool has a cylindrical shape, and the second step includes inserting the friction stir welding tool at a position that a central axis of the friction stir welding tool and the boundary are on a same straight line.
[5] In the current-carrying component manufacturing method according to the present invention, in the invention of the above-described [3], the friction stir welding tool has a cylindrical shape, and the second step includes inserting the friction stir welding tool at a position that the boundary is located within a diameter of the friction stir welding tool from one end to another end in the laminating direction.
[6] A current-carrying component according to the present invention includes: a first metal plate material; a second metal plate material having a thickness substantially same as the first metal plate material; a plate-shaped metal foil material in which a plurality of metal foils are laminated in a thickness direction, the metal foil having a thickness substantially same as the first metal plate material and the second metal plate material and being arranged between the first metal plate material and the second metal plate material, end surfaces of the metal foil material respectively facing the first metal plate material and the second metal plate material being abutted on an end surface of the first metal plate material and an end surface of the second metal plate material; a first joint formed by performing friction stir spot welding between the first metal plate material and the metal foil material, the first joint including a part of a boundary between the first metal plate material and the meta foil material; and a second joint formed by performing friction stir spot welding between the second metal plate material and the metal foil material, the second joint including a part of a boundary between the second metal plate material and the metal foil material.
[7] In the current-carrying component according to the present invention, in the invention of the above-described [6], the end surface of the first metal plate and the end surface of the metal foil material facing each other are planes substantially parallel to the thickness direction, and the end surface of the second metal plate material and the end surface of the metal foil material facing each other are planes substantially parallel to the thickness direction.
[8] In the current-carrying component according to the present invention, in the invention of the above-described [6], each of the end surface of the first metal plate material and the end surface of the metal foil material facing each other is an inclined surface that is inclined with respect to the thickness direction, and
   each of the end surface of the second metal plate material and the end surface of the metal foil material facing each other is an inclined surface that is inclined with respect to the thickness direction.

### Effect of the Invention

A current-carrying component manufacturing method and a current-carrying component according to the present invention have an effect of suppressing a thickness of a joint when the joint is formed between a metal foil material and a metal plate material by friction stir spot welding.

### BRIEF DESCRIPTION OF DRAWINGS

FIG. 1 is a plan view schematically illustrating a current-carrying component according to a first embodiment of the present invention.

FIG. 2 is a side view of the current-carrying Component in FIG. 1.

FIG. 3 is a cross-sectional view taken along line A-A in FIG. 1.

FIG. 4 is a diagram illustrating a first step and a second step of a method for manufacturing the current-carrying component in FIG. 1.

FIG. 5 is a diagram illustrating a first stage of a third step in the method for manufacturing the current-carrying component in FIG. 1.

FIG. 6 is a diagram illustrating a second stage of the third step in the method for manufacturing the current-carrying component in FIG. 1.

FIG. 7 is a diagram illustrating a state after completion of the third step in the method for manufacturing the current-carrying component in FIG. 1.

FIG. 8 is a cross-sectional view illustrating a state in which a burr is removed in a fourth step in the method for manufacturing the current-carrying component in FIG. 1.

FIG. 9 is a diagram illustrating a positional relationship between a recess and a boundary in FIG. 8.

FIG. 10 is a diagram illustrating a case where friction stir spot welding is performed with a central axis inclined with respect to the boundary in FIG. 9.

FIG. 11 is a diagram illustrating a case where the current-carrying component in FIG. 1 is assembled to battery cases having different heights.

FIG. 12 is a plan view schematically illustrating a current-carrying component according to a second embodiment of the present invention.

FIG. 13 is a side view of the current-carrying component in FIG. 12.

FIG. 14 is a cross-sectional view taken along line B-B in FIG. 12.

FIG. 15 is a diagram illustrating a first step and a second step in a method for manufacturing the current-carrying component in FIG. 12.

FIG. 16 is a diagram illustrating a first stage of a third step in the method for manufacturing the current-carrying component in FIG. 12.

FIG. 17 is a diagram illustrating a second stage of the third step in the method for manufacturing the current-carrying component in FIG. 12.

FIG. 18 is a diagram illustrating a state after completion of the third step in the method for manufacturing the current-carrying component in FIG. 12.

FIG. 19 is a cross-sectional view illustrating a state in which a burr is removed in a fourth step in the method for manufacturing the current-carrying component in FIG. 12.

FIG. 20 is a diagram illustrating a positional relationship between a recess and a boundary in FIG. 19.

FIG. 21 is a diagram illustrating a case where friction stir spot welding is performed with a central axis inclined with respect to the boundary in FIG. 20.

FIG. 22 is a diagram illustrating a case where an end surface of a metal plate material is positioned on an end surface of a metal foil material and butted together.

FIG. 23 is a diagram illustrating a case where friction stir spot welding is performed with the central axis inclined with respect to the boundary when the end surface of the metal plate material is positioned on the end surface of the metal foil material in FIG. 22 and butted together.

FIG. 24 is a cross-sectional view of a main part of a current-carrying component taken along a direction orthogonal to a thickness direction according to a third embodiment of the present invention.

### BEST MODE(S) OF CARRYING OUT THE INVENTION

### First Embodiment

Hereinafter, a current-carrying component manufacturing method and a current-carrying component according to a first embodiment of the present invention will be described. Note that the present invention is not limited by the present embodiment.

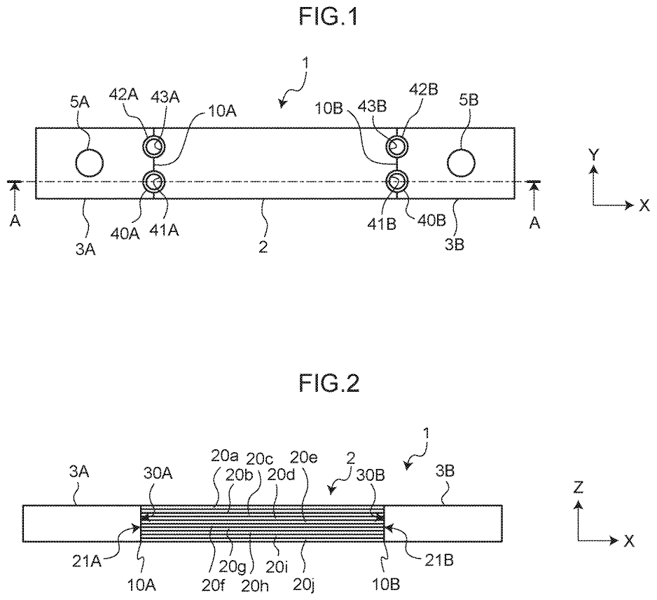

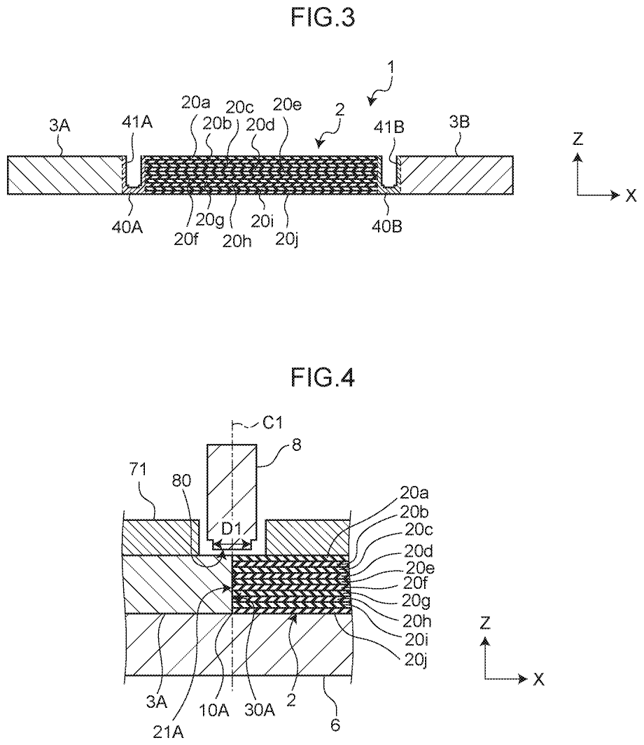

FIG. 1 is a plan view schematically illustrating a current-carrying component 1 according to the first embodiment of the present invention. FIG. 2 is a side view of the current-carrying component 1 in FIG. 1. FIG. 3 is a cross-sectional view taken along line A-A in FIG. 1. In the following description, a longitudinal direction of the current-carrying component 1 is simply referred to as a longitudinal direction X, a width direction of the current-carrying component 1 is simply referred to as a width direction Y, and a thickness direction of the current-carrying component 1 is simply referred to as a thickness direction Z.

As illustrated in FIGS. 1 and 2, the current-carrying component 1 according to the first embodiment includes a metal plate material 3A (first metal plate material) arranged at one end in the longitudinal direction X, and a metal foil material 2 arranged between the metal plate material 3A and a metal plate material 3B (second metal plate material) arranged at the other end in the longitudinal direction X. Still more, as illustrated in FIG. 1, holes 5A and 5B for fitting fastening members such as bolts are provided in the metal plate materials 3A and 3B located at both ends in the longitudinal direction X of the current-carrying component 1.

The metal foil material 2 is formed in a plate shape having a thickness substantially same as the metal plate materials 3A and 3B by laminating a plurality of strip-shaped metal foils 20a, 20b, 20c, 20d, 20e, 20f, 20g, 20h, 20i, and 20j in the thickness direction Z. A laminating direction of the plurality of metal foils 20a, 20b, 20c, 20d, 20e, 20f, 20g, 20h, 20i, and 20j in the metal foil material 2 is the same as the thickness direction Z. In the following description, the plurality of metal foils 20a, 20b, 20c, 20d, 20e, 20f, 20g, 20h, 201, and 20j are simply referred to as a metal foil 20 unless otherwise distinguished. Examples of the metal foil 20 include an aluminum alloy foil and a copper alloy foil. The thickness of the metal foil 20 is, for example, 0.2 [mm] or less.

An end surface 21A of the metal foil material 2 on the metal plate material 3A side in the longitudinal direction X is formed as a plane substantially parallel to the thickness direction Z of the metal foil material 2. Still more, an end surface 21B of the metal foil material 2 on the metal plate material 3B side in the longitudinal direction X is formed as a plane substantially parallel to the thickness direction Z of the metal foil material 2.

Examples of the metal plate materials 3A and 3B include an aluminum alloy plate and a copper alloy plate. The thickness of the metal plate materials 3A and 3B is, for example, 1 [mm] or more. An end surface 30A of the metal plate material 3A on the metal foil material 2 side in the longitudinal direction X is formed as a plane substantially parallel to the thickness direction Z of the metal plate material 3A. Still more, an end surface 30B of the metal plate material 3B on the metal foil material 2 side in the longitudinal direction X is formed as a plane substantially parallel to the thickness direction Z of the metal plate material 3B.

At one end in the longitudinal direction X of the current-carrying component 1, the end surface 21A of the metal foil material 2 and the end surface 30A of the metal plate material 3A are butted together (abutted) for surface contact. The metal foil material 2 and the metal plate material 3A are joined by friction stir spot welding at two joints 40A and 42A at which a part of a boundary 10A between the end surface 21A of the metal foil material 2 and the end surface 30A of the metal plate material 3A is included. As illustrated in FIGS. 1 and 3, the joints 40A and 42A are formed around hole-shaped recesses 41A and 43A that are insertion marks of a friction stir welding tool 8 (see FIG. 4), described later, that is inserted at predetermined intervals in the width direction Y of the current-carrying component 1. The joints 40A and 42A are portions where the metal foil material 2 and the metal plate material 3A, which have been plastically fluidized by friction stirring caused by the friction stir welding tool 8, are mixed and solid-phase welded (structurally and morphologically integrated).

At the other end in the longitudinal direction X of the current-carrying component 1, the end surface 21B of the metal foil material 2 and the end surface 30B of the metal plate material 3B are butted together (abutted) for surface contact. The metal foil material 2 and the metal plate material 3B are joined by friction stir spot welding at two joints 40B and 42B at which a part of a boundary 10B between the end surface 21B of the metal foil material 2 and the end surface 30B of the metal plate material 3B is included. As illustrated in FIGS. 1 and 3, the joints 40B and 42B are formed around hole-shaped recesses 41B and 43B that are insertion marks of the friction stir welding tool 8 inserted at predetermined intervals in the width direction Y of the current-carrying component 1. The joints 40B and 42B are portions where the metal foil material 2 and the metal plate material 3B, which have been plastically fluidized by friction stirring caused by the friction stir welding tool 8, are mixed and solid-phase welded.

In the current-carrying component 1 according to the first embodiment, the end surface 21A of the metal foil material 2 and the end surface 30A of the metal plate material 3A are butted together and joined, and the end surface 21B of the metal foil material 2 and the end surface 30B of the metal plate material 3B are butted together and joined. Thus, in the current-carrying component 1 according to the first embodiment, a thickness of a joint area can be reduced as compared with the case where the metal foil material 2 and the metal plate material 3A are stacked and joined in the thickness direction Z, and the metal foil material 2 and the metal plate material 3B are stacked and joined in the thickness direction Z. In addition, in the current-carrying component 1 according to the first embodiment, when the joints 40A, 42A, 40B, and 42B are formed on the metal foil material 2 and the metal plate materials 3A and 3B by friction stir spot welding, the thickness of the joints 40A, 42A, 40B, and 42B can be suppressed.

Next, a method for manufacturing the current-carrying component 1 according to the first embodiment will be described. In the method for manufacturing the current-carrying component 1 according to the first embodiment, a method for joining the metal foil material 2 and the metal plate material 3A at the joints 40A and 42A and a method for joining the metal foil material 2 and the metal plate material 3B at the joints 40B and 42B are the same. Therefore, here, a case where the metal foil material 2 and the metal plate material 3A are joined at the joint 40A by friction stir spot welding will be described as an example.

FIG. 4 is a diagram illustrating a first step and a second step in the method for manufacturing the current-carrying component 1 in FIG. 1.

First, in the first step, as illustrated in FIG. 4, the end surface 21A of the metal foil material 2 and the end surface 30A of the metal plate material 3A, which are planes substantially parallel to the thickness direction Z and facing each other, are placed on an installation base 6 in a butted state. Then, the metal foil material 2 and the metal plate material 3A are pressed from above by a plate-shaped pressing jig 71 to be fixed onto the installation base 6.

Next, in the second step, as illustrated in FIG. 4, the friction stir welding tool 8 attached to a welding device (not illustrated) is inserted into a through hole provided in the pressing jig 71. The friction stir welding tool 8 is arranged with respect to the metal foil material 2 and the metal plate material 3A such that a tip surface 80 of the friction stir welding tool 8 is slightly separated from upper surfaces of the metal foil material 2 and the metal plate material 3A. At this time, the friction stir welding tool 8 is arranged in the longitudinal direction X such that the boundary 10A between the end surface 21A of the metal foil material 2 and the end surface 30A of the metal plate material 3A and a central axis C1 of the friction stir welding tool 8 are positioned on the same straight line. In this way, in the second step, the friction stir welding tool 8 is arranged such that the boundary 10A is located within a diameter D1 in the longitudinal direction X of the tip surface 80 of the friction stir welding tool 8 from an upper end (one end) to a lower end (the other end) in the thickness direction Z.

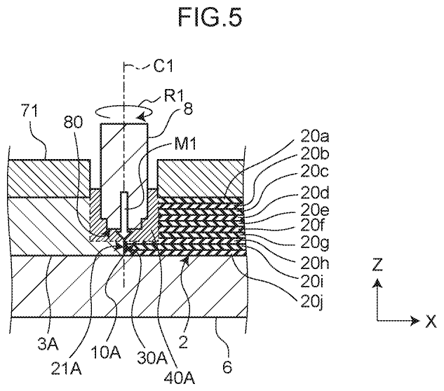

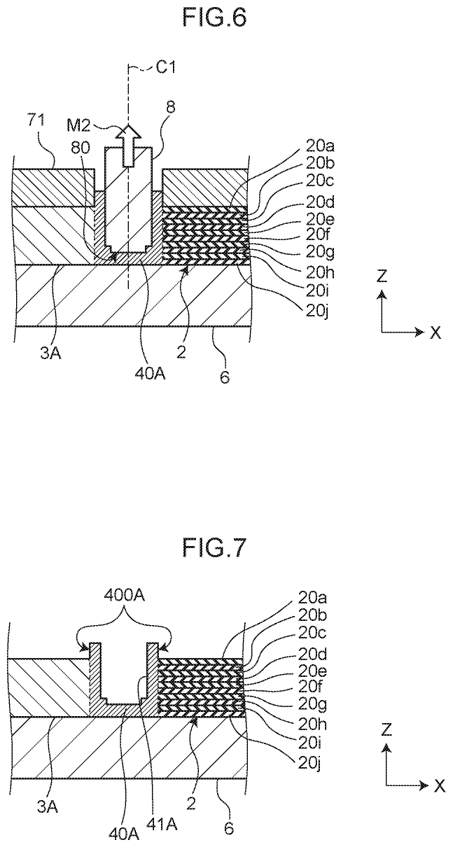

FIG. 5 is a diagram illustrating a first stage of a third step in the method for manufacturing the current-carrying component 1 in FIG. 1. FIG. 6 is a diagram illustrating a second stage of the third step in the method for manufacturing the current-carrying component 1 in FIG. 1. FIG. 7 is a diagram illustrating a state after completion of the third step in the method for manufacturing the current-carrying component 1 in FIG. 1.

In the first stage of the third step, as illustrated in FIG. 5, the friction stir welding tool 8 is lowered in a direction of an arrow M1 while being rotated at high speed at a predetermined rotation speed in a direction of an arrow R1 about the central axis C1 as a rotation center, and is inserted into the metal foil material 2 and the metal plate material 3A from the tip surface 80. At this time, the metal foil material 2 and the metal plate material 3A around the friction stir welding tool 8 rotating at high speed are softened by frictional heat and stirred by a rotational force of the friction stir welding tool 8 to be plastically fluidized and mixed. The predetermined rotation speed when the friction stir welding tool 8 is rotated at high speed is, for example, 5000 [rpm] to 9000 [rpm].

Next, in the second stage of the third step, as illustrated in FIG. 6, the rotation of the friction stir welding tool 8 is stopped after the tip surface 80 of the friction stir welding tool 8 reaches a predetermined position where the friction stir welding tool 8 does not penetrate the metal foil material 2 and the metal plate material 3A in the thickness direction Z. Then, the friction stir welding tool 8 is raised in a direction of an arrow M2, and the friction stir welding tool 8 is pulled out from the inside of the metal foil material 2 and the metal plate material 3A. As a result, as illustrated in FIG. 7, the joint 40A is formed by friction stir welding (solid phase welding) of the metal foil material 2 and the metal plate material 3A around the recess 41A that is the insertion mark of the friction stir welding tool 8. Still more, as illustrated in FIG. 7, a burr 400A is formed on a rim of the recess 41A. The burr 400A is formed when a part of each of the metal foil material 2 and the metal plate material 3A plastically fluidized by friction stirring enters a gap between the friction stir welding tool 8 and the pressing jig 71.

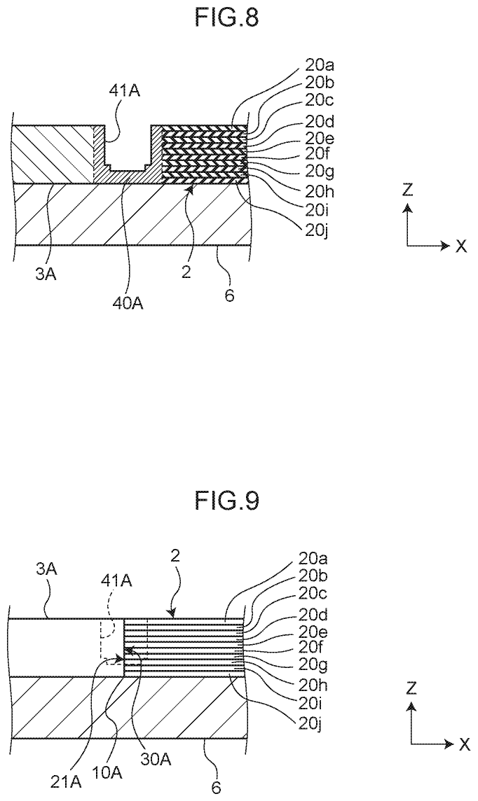

FIG. 8 is a cross-sectional view illustrating a state in which the burr 400A is removed in a fourth step in the method for manufacturing the current-carrying component 1 in FIG. 1. FIG. 9 is a diagram illustrating a positional relationship between the recess 41A and the boundary 10A in FIG. 8.

In the fourth step, the pressing jig 71 that has been fixing the metal foil material 2 and the metal plate material 3A is removed to secure a work space around the burr 400A, and the burr 400A is removed, as illustrated in FIG. 8, by an arbitrary burr removal method such as cutting.

In the method for manufacturing the current-carrying component 1 according to the first embodiment, the first to fourth steps are similarly performed on the joint 42A between the metal foil material 2 and the metal plate material 3A and the joints 40B and 42B between the metal foil material 2 and the metal plate material 3B to complete the manufacture of the current-carrying component 1.

As described above, the method for manufacturing the current-carrying component 1 according to the first embodiment is capable of manufacturing the current-carrying component 1 in which the thicknesses of the joints 40A, 42A, 40B, and 42B are suppressed to achieve a thickness substantially same as the thickness of each of the metal foil material 2 and the metal plate materials 3A and 3B. Still more, in the method for manufacturing the current-carrying component 1 according to the first embodiment, since the thickness of the joint 40A is suppressed, the joint 40A and components around the joint 40A are less likely to interfere with each other, thereby improving a degree of freedom in component design.

Furthermore, in the method for manufacturing the current-carrying component 1 according to the first embodiment, as illustrated in FIG. 9, the tip surface 80 of the friction stir welding tool 8 is inserted into the metal foil material 2 and the metal plate material 3A such that the boundary 10A is located in the recess 41A in the longitudinal direction X, and then friction stir spot welding is performed. As a result, in the method for manufacturing the current-carrying component 1 according to the first embodiment, friction stir spot welding can be performed while suppressing peeling up of the metal foil 20 of the metal foil material 2.

The method for manufacturing the current-carrying component 1 according to the first embodiment is not limited to the friction stir spot welding in which the central axis C1 of the friction stir welding tool 8 and the boundary 10A are positioned on the same straight line in the longitudinal direction X. For example, as long as the boundary 10A is within a range inside the recess 41A (diameter D1 of the tip surface 80 in the friction stir welding tool 8) in the longitudinal direction X, the central axis C1 and the boundary 10A may be parallel to each other and shifted from each other.

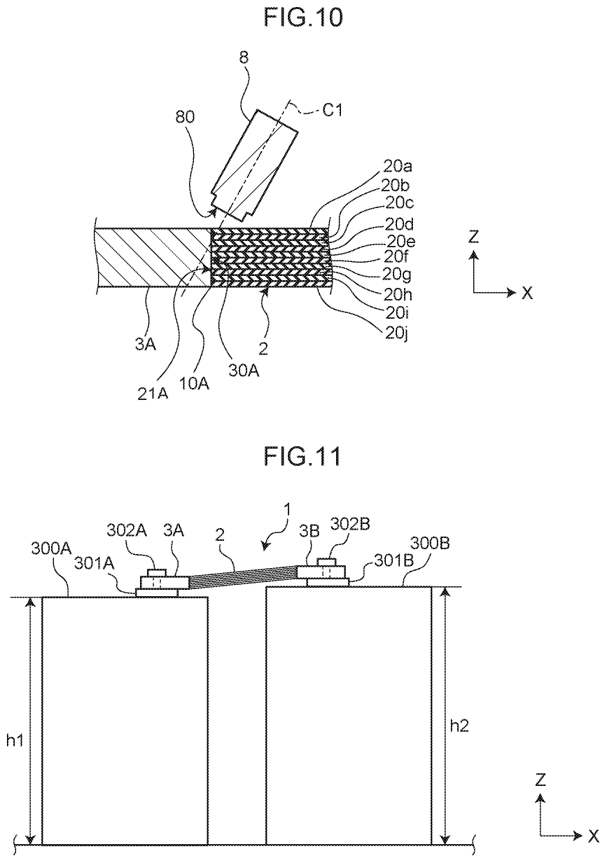

FIG. 10 is a diagram illustrating a case where friction stir spot welding is performed with the central axis C1 inclined with respect to the boundary 10A in FIG. 9.

In the method for manufacturing the current-carrying component 1 according to the first embodiment, for example, as illustrated in FIG. 10, friction stir spot welding may be performed by inclining the central axis C1 with respect to the boundary 10A by a predetermined angle so that the friction stir welding tool 8 approaches the metal foil material 2 side. As a result, the tip surface 80 of the friction stir welding tool 8 can be inserted mainly from the metal foil material 2 side to perform friction stir spot welding of the metal foil material 2 and the metal plate material 3A. Therefore, the tip surface 80 of the friction stir welding tool 8 can be inserted with a small rotation speed and a small rotational force as compared with the case where the tip surface 80 of the friction stir welding tool 8 is substantially simultaneously inserted into both the metal foil material 2 and the metal plate material 3A.

FIG. 11 is a diagram illustrating a case where the current-carrying component 1 in FIG. 1 is assembled to battery cases 300A and 300B having different heights.

The current-carrying component 1 according to the first embodiment can be used as, for example, a bus bar that electrically connects a plurality of battery cases mounted on an electric vehicle.

For example, as illustrated in FIG. 11, the current-carrying component 1 according to the first embodiment is used as the bus bar for electrically connecting the battery cases 300A and 300B having different heights. As described above, when the current-carrying component 1 is assembled to the battery cases 300A and 300B having different heights, the metal foil material 2 is flexibly deformed according to the difference between a height h1 of the battery case 300A and a height h2 of the battery case 300B. In particular, in the current-carrying component 1 according to the first embodiment, since the end surface 21A of the metal foil material 2 and the end surface 30A of the metal plate material 3A, and the end surface 21B of the metal foil material 2 and the end surface 30B of the metal plate material 3B are butted and joined, the metal foil material 2 can be designed to have a broad movable range. Thus, the flexibility of the current-carrying component 1 (metal foil material 2) according to the first embodiment can be improved. Therefore, workability can be improved when the metal plate materials 3A and 3B of the current-carrying component 1 are fastened and connected to connecting portions 301A and 301B of the battery cases 300A and 300B by bolts 302A and 302B that are fastening members. Still more, flexible deformation of the metal foil material 2 makes it possible to suppress a decrease in a contact area between the metal plate materials 3A and 3B and connecting portions 301A and 301B fastened by the bolts 302A and 302B.

Furthermore, an allowable height difference between the battery cases 300A and 300B can be made larger than that of a current-carrying component (bus bar) formed only of a metal plate material. Therefore, the thickness of the current-carrying component 1 according to the first embodiment can be increased so as to support, for example, a large current of 1000 [A] or more.

As described above, in the current-carrying component 1 according to the first embodiment, the thickness of the joints 40A, 42A, 40B, and 42B can be suppressed, and the region where the metal foil material 2 can be deformed is large, so that the current-carrying component 1 can be manufactured as a bus bar having high flexibility. As a result, when the current-carrying component 1 according to the first embodiment is used as the bus bar, the bus bar has high flexibility, and thus the bus bar can be easily assembled to the battery cases 300A and 300B. In addition, when a large positional displacement occurs in the battery cases 300A and 300B due to vibration or the like, high flexibility of the bus bar enables the bus bar to deform according to the positional displacement. Thus, the bus bar hardly breaks at a bolt-fastened portion.

### Second Embodiment

Hereinafter, a current-carrying component manufacturing method and a current-carrying component according to a second embodiment of the present invention will be described. Note that description of the second embodiment similar to that of the first embodiment will be omitted as appropriate.

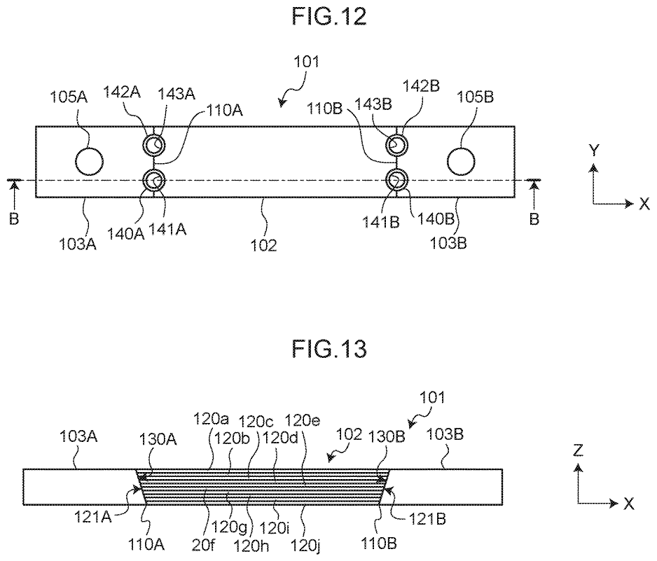

FIG. 12 is a plan view schematically illustrating a current-carrying component 101 according to the second embodiment of the present invention. FIG. 13 is a side view of the current-carrying component 101 in FIG. 12.

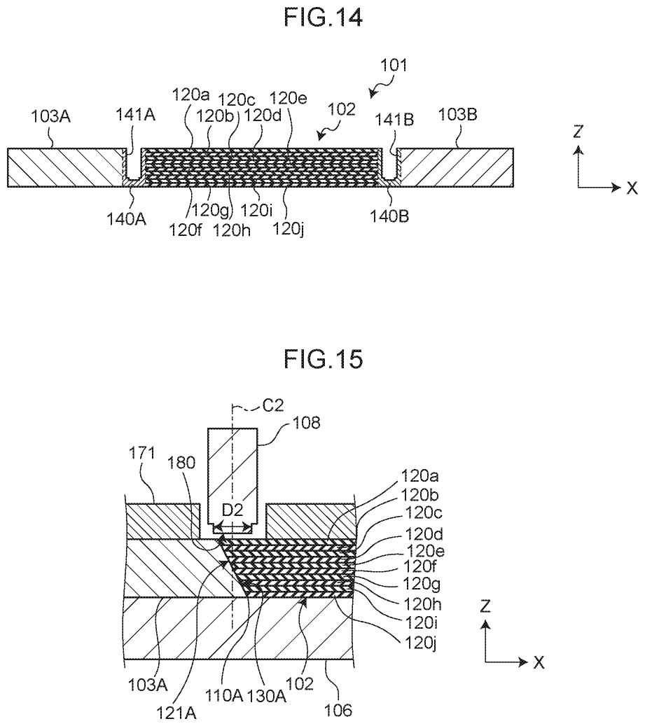

FIG. 14 is a cross-sectional view taken along line B-B in FIG. 12.

As illustrated in FIGS. 12 and 13, the current-carrying component 101 according to the second embodiment is configured by arranging a metal foil material 102 between a metal plate material 103A (first metal plate material) and a metal plate material 103B (second metal plate material) in the longitudinal direction X. As illustrated in FIG. 12, holes 105A and 105B for fitting fastening members such as bolts are provided in the metal plate materials 103A and 103B located at both ends in the longitudinal direction X of the current-carrying component 101. The current-carrying component 101 according to the second embodiment can be used, for example, as a bus bar that electrically connects a plurality of battery cases mounted on an electric vehicle.

The metal foil material 102 is formed in a plate shape having a thickness substantially same as the metal plate materials 103A and 103B by laminating a plurality of strip-shaped metal foils 120a, 120b, 120c, 120d, 120e, 120f, 120g, 120h, 120i, and 120j in the thickness direction Z.

The laminating direction of the plurality of metal foils 120a, 120b, 120c, 120d, 120e, 120f, 120g, 120h, 120i, and 120j in the metal foil material 102 is the same as the thickness direction Z. In the following description, the plurality of metal foils 120a, 120b, 120c, 120d, 120e, 120f, 120g, 120h, 120i, and 120j are simply referred to as a metal foil 120 unless otherwise distinguished. Examples of the metal foil 120 include an aluminum alloy foil and a copper alloy foil. The thickness of the metal foil 120 is, for example, 0.2 [mm] or less.

An end surface 121A of the metal foil material 102 on the metal plate material 103A side in the longitudinal direction X is an inclined surface inclined downward from the outside to the inside in the longitudinal direction X from an upper end (one end) to a lower end (the other end) in the thickness direction Z. An end surface 121B of the metal foil material 102 on the metal plate material 103B side in the longitudinal direction X is formed as an inclined surface inclined downward from the outside to the inside in the longitudinal direction X from the upper end (one end) to the lower end (the other end) in the thickness direction Z.

Examples of the metal plate materials 103A and 103B include an aluminum alloy plate and a copper alloy plate.

The thicknesses of the metal plate materials 103A and 103B are, for example, 1 [mm] or more. An end surface 130A of the metal plate material 103A on the metal foil material 102 side in the longitudinal direction X is an inclined surface inclined downward from the inside to the outside in the longitudinal direction X from the upper end (one end) to the lower end (the other end) in the thickness direction Z. An end surface 130B of the metal plate material 103B on the metal foil material 102 side in the longitudinal direction X is an inclined surface inclined downward from the inside to the outside in the longitudinal direction X from the upper end (one end) to the lower end (the other end) in the thickness direction Z.

At one end in the longitudinal direction X of the current-carrying component 101, the end surface 121A of the metal foil material 102 and the end surface 130A of the metal plate material 103A are butted together for surface contact so that the end surface 121A of the metal foil material 102 in the thickness direction Z is positioned on the end surface 130A of the metal plate material 103A. The metal foil material 102 and the metal plate material 103A are joined by friction stir spot welding at two joints 140A and 142A at which a part of a boundary 110A between the end surface 121A of the metal foil material 102 and the end surface 130A of the metal plate material 103A is included. As illustrated in FIGS. 12 and 14, the joints 140A and 142A are formed around hole-shaped recesses 141A and 143A that are insertion marks of a friction stir welding tool 108 (see FIG. 15), described later, that is inserted at predetermined intervals in the width direction Y of the current-carrying component 101. The joints 140A and 142A are portions where the metal foil material 102 and the metal plate material 103A, which have been plastically fluidized by friction stirring caused by the friction stir welding tool 108, are mixed and solid-phase welded (structurally and morphologically integrated).

At the other end in the longitudinal direction X of the current-carrying component 101, the end surface 121B of the metal foil material 102 and the end surface 130B of the metal plate material 103B are butted together for surface contact so that the end surface 121B of the metal foil material 102 in the thickness direction Z is positioned on the end surface 130B of the metal plate material 103B. The metal foil material 102 and the metal plate material 103B are joined by friction stir spot welding at two joints 140B and 142B at which a part of a boundary 110B between the end surface 121B of the metal foil material 102 and the end surface 130B of the metal plate material 103B is included. As illustrated in FIGS. 12 and 14, the joints 140B and 142B are formed around hole-shaped recesses 141B and 143B that are insertion marks of the friction stir welding tool 108 inserted at predetermined intervals in the width direction Y of the current-carrying component 101. The joints 140B and 142B are portions where the metal foil material 102 and the metal plate material 103B, which have been plastically fluidized by friction stirring caused by the friction stir welding tool 108, are mixed and solid-phase welded.

In the current-carrying component 101 according to the second embodiment, the end surface 121A of the metal foil material 102 and the end surface 130A of the metal plate material 103A are butted and joined, and the end surface 121B of the metal foil material 102 and the end surface 130B of the metal plate material 103B are butted and joined. Thus, in the current-carrying component 101 according to the second embodiment, the thickness of a joint area can be reduced as compared with the case where the metal foil material 102 and the metal plate material 103A are stacked and joined in the thickness direction Z, and the metal foil material 102 and the metal plate material 103B are stacked and joined in the thickness direction Z. In addition, the current-carrying component 101 according to the second embodiment can suppress the thicknesses of the joints 140A, 142A, 140B, and 142B when the joints 140A, 142A, 140B, and 142B are formed on the metal foil material 102 and the metal plate materials 103A and 103B by friction stir spot welding.

In the current-carrying component 101 according to the second embodiment, the end surface 121A of the metal foil material 102 and the end surface 130A of the metal plate material 103A are inclined surfaces inclined with respect to the thickness direction Z. As a result, in the current-carrying component 101 according to the second embodiment, the contact area between the end surface 121A of the metal foil material 102 and the end surface 130A of the metal plate material 103A can be made larger than that when the end surface 121A and the end surface 130A are planes substantially parallel to the thickness direction Z. As a result, bonding property can be enhanced.

Next, a method for manufacturing the current-carrying component 101 according to the second embodiment will be described. In the method for manufacturing the current-carrying component 101 according to the second embodiment, a method for joining the metal foil material 102 and the metal plate material 103A at the joints 140A and 142A and a method for joining the metal foil material 102 and the metal plate material 103B at the joints 140B and 142B are the same. Therefore, here, a case where the metal foil material 102 and the metal plate material 103A are joined at the joint 140A by friction stir spot welding will be described as an example.

FIG. 15 is a diagram illustrating a first step and a second step in the method for manufacturing the current-carrying component 101 in FIG. 12.

First, in the first step, as illustrated in FIG. 15, the end surface 121A of the metal foil material 102 and the end surface 130A of the metal plate material 103A, which are inclined surfaces inclined with respect to the thickness direction Z and face each other, are placed on an installation base 106 in a butted state (abutted). Then, the metal foil material 102 and the metal plate material 103A are pressed from above by a plate-shaped pressing jig 171 and fixed on the installation base 106.

Next, in the second step, as illustrated in FIG. 15, the friction stir welding tool 108 attached to a welding device (not illustrated) is inserted into a through hole provided in the pressing jig 171. The friction stir welding tool 108 is arranged with respect to the metal foil material 102 and the metal plate material 103A such that a tip surface 180 of the friction stir welding tool 108 is slightly separated from upper surfaces of the metal foil material 102 and the metal plate material 103A. At this time, in the longitudinal direction X, the boundary 110A between the end surface 121A of the metal foil material 102 and the end surface 130A of the metal plate material 103A is located within a diameter D2 of the tip surface 180 of the friction stir welding tool 108 from an upper end (one end) to a lower end (the other end) in the thickness direction Z.

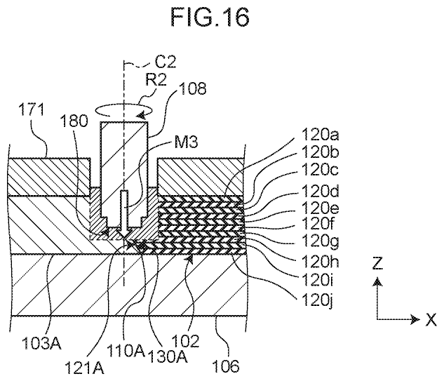

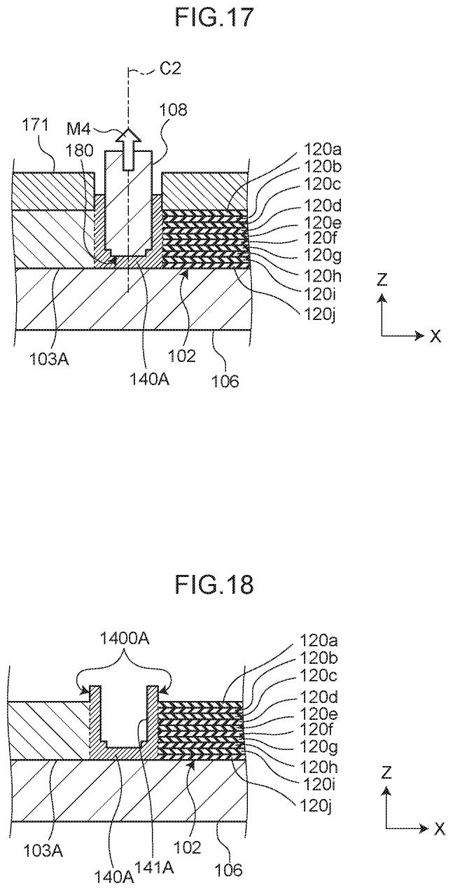

FIG. 16 is a diagram illustrating a first stage of a third step in the method for manufacturing the current-carrying component 101 in FIG. 12. FIG. 17 is a diagram illustrating a second stage of the third step in the method for manufacturing the current-carrying component 101 in FIG. 12. FIG. 18 is a diagram illustrating a state after completion of the third step in the method for manufacturing the current-carrying component 101 in FIG. 12.

In the first stage of the third step, as illustrated in FIG. 16, the friction stir welding tool 108 is lowered in a direction of an arrow M3 while being rotated at high speed at a predetermined rotation speed in a direction of an arrow R2 about a central axis C2 as a rotation center, and is inserted into the metal foil material 102 and the metal plate material 103A from the tip surface 180. At this time, the metal foil material 102 and the metal plate material 103A around the friction stir welding tool 108 rotating at high speed are softened by frictional heat and stirred by a rotational force of the friction stir welding tool 8 to be plastically fluidized and mixed. The predetermined rotation speed when the friction stir welding tool 108 is rotated at high speed is, for example, 5000 [rpm] to 9000 [rpm].

Next, in the second stage of the third step, as illustrated in FIG. 17, the rotation of the friction stir welding tool 108 is stopped after the tip surface 180 of the friction stir welding tool 108 reaches a predetermined position not penetrating the metal foil material 102 and the metal plate material 103A in the thickness direction Z. Then, the friction stir welding tool 108 is raised in a direction of an arrow M4, and the friction stir welding tool 108 is pulled out from the inside of the metal foil material 102 and the metal plate material 103A. As a result, as illustrated in FIG. 18, the joint 140A is formed by friction stir welding (solid phase welding) of the metal foil material 102 and the metal plate material 103A around the recess 141A that is the insertion mark of the friction stir welding tool 108. As illustrated in FIG. 18, a burr 1400A is formed on a rim of the recess 141A. The burr 1400A is formed when a part of each of the metal foil material 102 and the metal plate material 103A plastically fluidized by friction stirring enters a gap between the friction stir welding tool 108 and the pressing jig 171.

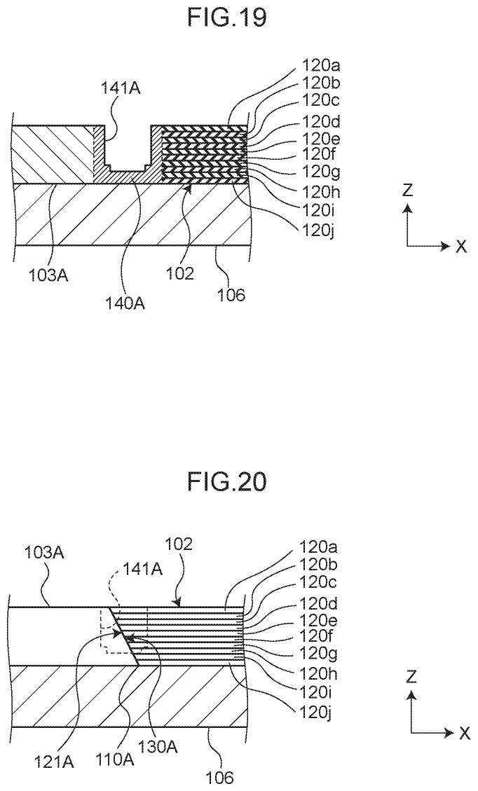

FIG. 19 is a cross-sectional view illustrating a state in which the burr 1400A is removed in a fourth step in the method for manufacturing the current-carrying component 101 in FIG. 12. FIG. 20 is a diagram illustrating a positional relationship between the recess 141A and the boundary 110A in FIG. 19.

In the fourth step, the pressing jig 171 that has been fixing the metal foil material 102 and the metal plate material 103A is removed to secure a work space around the burr 1400A, and the burr 1400A is removed, as illustrated in FIG. 19, by an arbitrary burr removal method such as cutting.

In the method for manufacturing the current-carrying component 101 according to the second embodiment, the first to fourth steps are similarly performed for the joint 142A between the metal foil material 102 and the metal plate material 103A and the joints 140B and 142B between the metal foil material 102 and the metal plate material 103B. Thus, in the method for manufacturing the current-carrying component 101 according to the second embodiment, the manufacture of the current-carrying component 101 is completed.

As described above, in the method for manufacturing the current-carrying component 101 according to the second embodiment, it is possible to manufacture the current-carrying component 101 in which the thickness of the joints 140A, 142A, 140B, and 142B is suppressed to achieve a thickness substantially same as the thickness of each of the metal foil material 102 and the metal plate materials 103A and 103B. As a result, in the method for manufacturing the current-carrying component 101 according to the second embodiment, the joints 140A, 142A, 140B, and 142B and components therearound are less likely to interfere with each other, thereby improving a degree of freedom in component design.

Still more, in the current-carrying component 101 according to the second embodiment, the thickness of the joints 140A, 142A, 140B, and 142B can be suppressed, and the region where the metal foil material 102 can be deformed is large, so that the current-carrying component 101 can be manufactured as a bus bar having high flexibility.

Furthermore, in the method for manufacturing the current-carrying component 101 according to the second embodiment, as illustrated in FIG. 20, the tip surface 180 of the friction stir welding tool 108 is inserted into the metal foil material 102 and the metal plate material 103A such that the boundary 110A is located in the recess 141A in the longitudinal direction X, and then friction stir spot welding is performed. Thus, in the method for manufacturing the current-carrying component 101 according to the second embodiment, friction stir spot welding can be performed while suppressing peeling up of the metal foil 120 of the metal foil material 102.

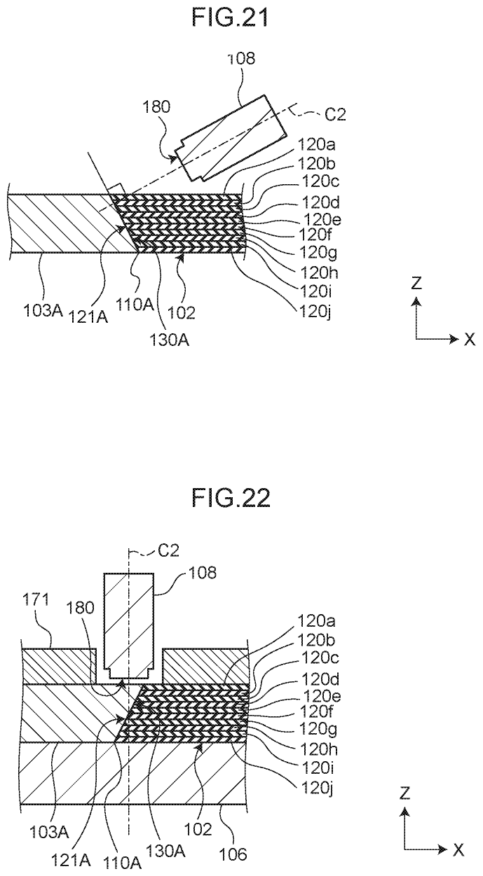

FIG. 21 is a diagram illustrating a case where friction stir spot welding is performed with the central axis C2 inclined with respect to the boundary 110A in FIG. 20.

In the method for manufacturing the current-carrying component 101 according to the second embodiment, for example, as illustrated in FIG. 21, friction stir spot welding may be performed by inclining the central axis C2 with respect to the boundary 110A by 90° so that the friction stir welding tool 108 approaches the metal foil material 102 side. As a result, the tip surface 180 of the friction stir welding tool 108 can be inserted mainly from the metal foil material 102 side to perform friction stir spot welding of the metal foil material 102 and the metal plate material 103A. Therefore, the tip surface 180 of the friction stir welding tool 108 can be inserted with a small rotation speed and a small rotational force as compared with the case where the tip surface 180 of the friction stir welding tool 108 is substantially simultaneously inserted into both the metal foil material 102 and the metal plate material 103A.

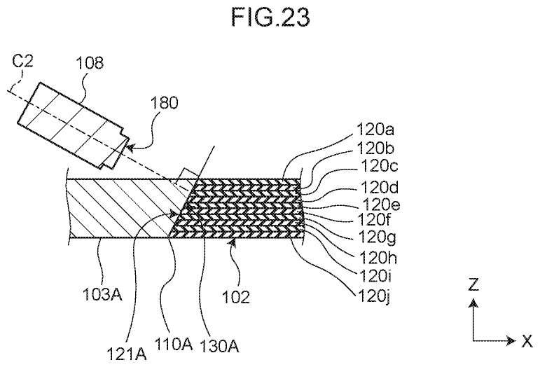

FIG. 22 is a diagram illustrating a case where the end surface 130A of the metal plate material 103A is positioned on the end surface 121A of the metal foil material 102 and butted together. FIG. 23 is a diagram illustrating a case where friction stir spot welding is performed with the central axis C2 inclined with respect to the boundary 110A when the end surface 130A of the metal plate material 103A is positioned on the end surface 121A of the metal foil material 102 in FIG. 22 and butted together.

In the method for manufacturing the current-carrying component 101 according to the second embodiment, for example, as illustrated in FIG. 22, the end surface 121A of the metal foil material 102 may be an inclined surface inclined downward from the inside to the outside in the longitudinal direction X from the upper end to the lower end in the thickness direction Z. The end surface 130A of the metal plate material 103A may be an inclined surface inclined downward from the outside to the inside in the longitudinal direction X from the upper end to the lower end in the thickness direction Z. In the method for manufacturing the current-carrying component 101 according to the second embodiment, the end surface 130A of the metal plate material 103A may be abutted to be positioned on the end surface 121A of the metal foil material 102 in the thickness direction Z, and the first to fourth steps described above may be performed to perform friction stir spot welding. At this time, for example, as illustrated in FIG. 23, friction stir spot welding may be performed by inclining the central axis C2 with respect to the boundary 110A by 90° so that the friction stir welding tool 108 approaches the metal plate material 103A side.

### Third Embodiment

Hereinafter, a current-carrying component manufacturing method and a current-carrying component according to a third embodiment of the present invention will be described. Note that description of the third embodiment similar to that of the first embodiment will be omitted as appropriate. The current-carrying component manufacturing method according to the third embodiment is basically the same as the current-carrying component manufacturing method according to the first embodiment except for time during which a metal foil material and a metal plate material are frictionally stirred by inserting a friction stir welding tool rotated at high speed. Further, the current-carrying component according to the third embodiment is basically the same as the current-carrying component according to the first embodiment except for a state of a joint that joins the metal foil material and the metal plate material.

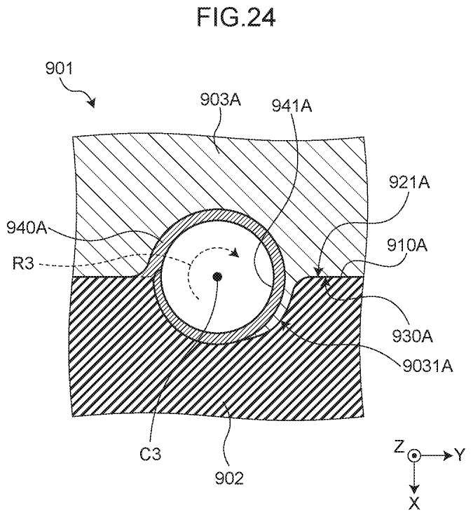

FIG. 24 is a cross-sectional view of a main part of a current-carrying component 901 taken along a direction orthogonal to the thickness direction Z according to the third embodiment of the present invention.

In the current-carrying component 901 according to the third embodiment, at one end in the longitudinal direction X of the current-carrying component 901, as illustrated in FIG. 24, an end surface 921A of a metal foil material 902 on which a plurality of metal foils are laminated and an end surface 930A of a metal plate material 903A are butted together (abutted) for surface contact. The end surface 921A of the metal foil material 902 and the end surface 930A of the metal plate material 903A abutting each other are planes substantially parallel to the thickness direction Z. The metal foil material 902 and the metal plate material 903A are subjected to friction stir spot welding by a friction stir welding tool (not illustrated) at a position including a part of a boundary 910A between the end surface 921A of the metal foil material 902 and the end surface 930A of the metal plate material 903A.

In the method for manufacturing the current-carrying component 901 according to the third embodiment, the friction stir welding tool is inserted into the metal foil material 902 and the metal plate material 903A from a tip surface of the friction stir welding tool while being rotated at high speed at a predetermined rotation speed in a direction of an arrow R3 about a central axis C3 as a rotation center. At this time, time from when the tip surface of the friction stir welding tool contacts the metal foil material 902 and the metal plate material 903A to when the tip surface reaches a predetermined position in the thickness direction Z and the friction stir welding tool is started to be pulled out is set to be shorter than that in the method for manufacturing the current-carrying component 1 according to the first embodiment. In other words, in the method for manufacturing the current-carrying component 901 according to the third embodiment, the time during which the friction stir welding tool rotated at high speed is inserted and the metal foil material 902 and the metal plate material 903A are frictionally stirred is shorter than that in the method for manufacturing the current-carrying component 1 according to the first embodiment.

As a result, in the current-carrying component 901 according to the third embodiment, a joint 940A is formed along the rotation direction of the friction stir welding tool over an entire circumference of a recess 941A that is an insertion mark of the friction stir welding tool. The joint 940A is a solid-phase joint in which a part of the metal foil material 902 is plastically fluidized toward the metal plate material 903A by the rotational force of the friction stir welding tool, and the metal foil material 902 and the metal plate material 903A are softened by frictional heat and stirred and mixed by the rotational force.

In addition, in the current-carrying component 901 according to the third embodiment, a part of the metal plate material 903A is pulled by the rotational force of the friction stir welding tool, and a plate material fluidized portion 9031A plastically fluidized toward the metal foil material 902 is formed at a part of a periphery of the recess 941A via the joint 940A.

The plate material fluidized portion 9031A is formed, for example, in an angular range up to about 90° along the periphery of the recess 941A on the metal foil material 902 side from the boundary 910A around the central axis C3 of the friction stir welding tool. The angular range in which the plate material fluidized portion 9031A is formed is not limited to the angular range up to about 90°.

In the current-carrying component 901 according to the third embodiment, since a part of the metal plate material 903A having strength higher than that of the metal foil material 902 is plastically fluidized toward the metal foil material 902, a breaking strength of the metal foil material 902 is increased, and a breaking strength of an entire component can be improved.

As the current-carrying component 901 according to the third embodiment, the end surface 921A of the metal foil material 902 and the end surface 930A of the metal plate material 903A abutting each other may be inclined surfaces inclined with respect to the thickness direction Z. At this time, as the method for manufacturing the current-carrying component 901 according to the third embodiment, for example, conditions may be basically the same as those of the method for manufacturing the current-carrying component 101 according to the second embodiment except for the time during which the friction stir welding tool rotated at high speed is inserted and the metal foil material and the metal plate material are frictionally stirred.

### EXPLANATIONS OF LETTERS OR NUMERALS

1, 101, 901 CURRENT-CARRYING COMPONENT
2, 102, 902 METAL FOIL MATERIAL
3A, 103A, 903A METAL PLATE MATERIAL
3B, 103B METAL PLATE MATERIAL
5A, 5B, 105A, 105B HOLE
6, 106 INSTALLATION BASE
8, 108 FRICTION STIR WELDING TOOL
10A, 110A, 910A BOUNDARY
10B, 110B BOUNDARY
20, 120 METAL FOIL
21A, 30A, 121A, 130A, 921A, 930A END SURFACE
21B, 30B, 121B, 130B END SURFACE
40A, 42A, 140A, 142A, 940A JOINT
40B, 42B, 140B, 142B JOINT
41A, 43A, 141A, 143A RECESS
41B, 43B, 141B, 143B RECESS
71, 171 PRESSING JIG
80, 180 TIP SURFACE
300A, 300B BATTERY CASE
301A, 301B CONNECTING PORTION
302A, 302B BOLT
400A, 1400A BURR
9031A PLATE MATERIAL FLUIDIZED PORTION

1. A current-carrying component manufacturing method, comprising
a first step of abutting an end surface of a plate-shaped metal foil material in which a plurality of metal foils are laminated and an end surface of a metal plate material having a thickness substantially same as the metal foil material in a laminating direction of the plurality of metal foils; and
a second step of performing friction stir spot welding between the metal foil material and the metal plate material by rotating and inserting a friction stir welding tool into the metal foil material and the metal plate material at a position including a part of a boundary between the end surface of the metal foil material and the end surface of the metal plate material butted together.

2. The current-carrying component manufacturing method according to claim 1, wherein
the end surface of the metal plate material and the end surface of the metal foil material butted together are planes substantially parallel to the laminating direction.

3. The current-carrying component manufacturing method according to claim 1, wherein
each of the end surface of the metal plate material and the end surface of the metal foil material butted together is an inclined surface that is inclined with respect to the laminating direction.

4. The current-carrying component manufacturing method according to claim 2, wherein
the friction stir welding tool has a cylindrical shape, and
the second step includes inserting the friction stir welding tool at a position that a central axis of the friction stir welding tool and the boundary are on a same straight line.

5. The current-carrying component manufacturing method according to claim 3, wherein
the friction stir welding tool has a cylindrical shape, and
the second step includes inserting the friction stir welding tool at a position that the boundary is located within a diameter of the friction stir welding tool from one end to another end in the laminating direction.

6. A current-carrying component comprising:
a first metal plate material;
a second metal plate material having a thickness substantially same as the first metal plate material;
a plate-shaped metal foil material in which a plurality of metal foils are laminated in a thickness direction, the metal foil having a thickness substantially same as the first metal plate material and the second metal plate material and being arranged between the first metal plate material and the second metal plate material, end surfaces of the metal foil material respectively facing the first metal plate material and the second metal plate material being abutted on an end surface of the first metal plate material and an end surface of the second metal plate material;
a first joint formed by performing friction stir spot welding between the first metal plate material and the metal foil material, the first joint including a part of a boundary between the first metal plate material and the meta foil material; and
a second joint formed by performing friction stir spot welding between the second metal plate material and the metal foil material, the second joint including a part of a boundary between the second metal plate material and the metal foil material.

7. The current-carrying component according to claim 6, wherein
the end surface of the first metal plate and the end surface of the metal foil material facing each other are planes substantially parallel to the thickness direction, and
the end surface of the second metal plate material and the end surface of the metal foil material facing each other are planes substantially parallel to the thickness direction.

8. The current-carrying component according to claim 6, wherein
each of the end surface of the first metal plate material and the end surface of the metal foil material facing each other is an inclined surface that is inclined with respect to the thickness direction, and
each of the end surface of the second metal plate material and the end surface of the metal foil material facing each other is an inclined surface that is inclined with respect to the thickness direction.
